(19) United States
(12) Patent Application Publication
(10) Pub. No.: US 2019/0356722 A1
(43) Pub. Date: Nov. 21, 2019

(54) Digital Signage Content Management System

(71) Applicant: Adobe Inc., San Jose, CA (US)

(72) Inventor: Kalyanaraman Balasubramaniam Krishnan, Sunnyvale, CA (US)

(73) Assignee: Adobe Inc., San Jose, CA (US)

(21) Appl. No.: 15/980,573

(22) Filed: May 15, 2018

(51) Int. Cl. H04L 29/08; H04L 29/06

(52) U.S. Cl. CPC H04L 67/025; H04L 63/0876; H04L 63/083; H04L 67/303

(57) ABSTRACT

A digital signage management system is described that employs techniques to provision digital signage devices. In one example, the digital signage management system generates configuration profiles automatically and without user intervention in a language-independent data format. The configuration profiles are generated to include device identifiers, content identifiers including network addresses indicative of where to obtain digital content, and authentication data that is usable as credentials to authorize access of the digital signage device to the digital content. The configuration profiles, once installed by respective digital signage devices, thus configure the devices for immediate access to digital content.

### BACKGROUND

Digital signage devices are implemented to support a remotely managed display of a variety of digital content by a digital signage management system. As such, digital signage devices may be found in a diverse range of environments to provide an equally diverse range of digital content. For example, digital signage devices may be found at stadiums, hotels, restaurants, corporate buildings, transportation terminals, physical stores, roadside billboards, and so forth. Further, digital signage devices may be configured to provide directions, instructions, advertisements, warnings, and so forth at these different locations using a display of text, animated or video messages, and so on.

Digital signage management systems typically follow an author/publish setup in which digital content is authored by the system on an authoring instance that lies within a corporate firewall. The digital content is then replicated to publish instances of the digital content to distributed locations of the digital signage devices. In practice, this may involve a multitude of digital signage devices, e.g., over ten thousand in some real-world examples.

However, conventional techniques used to provision and deploy digital signage devices are inefficient and prone to error. This may involve assembling the digital signage devices offsite which may not have network access or access to a publish or author instance at the time of assembling and then installing the device onsite at a desired geographic location that may be hard to reach or subsequently modify. Continuing with the previous example, suppose a technician requires fifteen minutes to manually configure each digital signage device. At an hourly cost of one hundred and fifty dollars an hour for the technician, alone, hundreds of thousands of dollars may be spent to provision ten thousand digital signage devices. This is further complicated by the diverse range of device configurations that may be used to implement digital signage devices, from smart TVs to USB sticks to roadside billboards that may have differing functionality and input techniques. For example, a smart TV may be operated primarily by remote control, which makes it difficult to perform data entry. As such, the diverse range of device configurations may require specialized knowledge by a technician that is tasked with setting up these devices.

### SUMMARY

A digital signage management system is described that employs techniques to provision digital signage devices. In one example, the digital signage management system generates configuration profiles based on a registration template automatically and without user intervention in a language-independent data format, and thus may be employed by a diverse range of device configurations.

The configuration profiles are generated to include device identifiers, content identifiers including network addresses indicative of where to obtain digital content, and authentication data that is usable as credentials to authorize access of the digital signage device to the digital content. The configuration profiles, once installed by respective digital signage devices, thus configure the devices for immediate access to digital content. This conserves user resources and improving operational efficiency of the digital signage devices and digital signage management system as a whole.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ digital signage content management techniques described herein.

FIG. 2 depicts a system showing operation of a signage provisioning module of FIG. 1 in greater detail.

FIG. 3 is a flow diagram depicting a procedure in an example implementation of generation of configuration profiles that are executable by a digital signage device to automatically provision digital signage devices for operation with a digital signage management system.

FIG. 4 depicts a system showing operation of a signage provisioning module of FIG. 1 in greater detail as installing configuration profiles on respective digital signage devices.

FIG. 5 is a flow diagram depicting a procedure in an example implementation of use of configuration profiles as generated with respect to FIGS. 2-3 to provision digital signage devices.

FIG. 6 depicts a system in which the digital signage device, as provisioned using the configuration profile of FIG. 4, launches automatically to obtain and render digital content from a digital signage management system.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

Overview

Conventional techniques to provision digital signage devices often fail due to the complexity and diverse range of a multitude of digital signage devices that may be employed, even for a single digital signage management system. In practice, a digital signage management system may be configured to manage tens of thousands of digital signage devices. These digital signage devices may be implemented in a variety of configurations for output of a diverse range of digital content. Consequently, conventional techniques that require manual provisioning of each of the multitude of digital signage devices are tedious, require specialized knowledge, and are prone to failure due to human error and lack of testing.

Digital signage content management systems and techniques are described that support automated provisioning and testing of digital signage devices for output of digital content. As a result, these techniques may improve efficiency and accuracy both with respect to user interaction as well as operational efficiency of these devices and the system as a whole. In one example, a digital signage management system generates configuration profiles that are leveraged by respective digital signage devices to provision the devices. This may include supplying credentials that are usable to authenticate the digital signage devices to the content management system as well as specifying what digital content is to be output by the devices, e.g., through use of a URL by specifying a path to the digital content that is to be downloaded that may be device specific.

In order to generate the configuration profiles, the digital signage management system generates default parameters for respective digital signage devices through use of a registration template. The registration template may leverage a regular expression of device identifiers using asset tags or unique IDs that may be specific to an enterprise or management software. The digital signage management system, for instance, may employ a naming convention that is usable to generate asset tags to uniquely identify digital signage devices within the system. In instances in which a regular expression is not available, inputs may be received via a spreadsheet or comma separated values (CSV) file that includes the device identifiers.

The configuration profiles are usable to “pre-register” the digital signage devices using the registration templates as part of the digital signage management system. As such, the configuration profiles may be generated and tested even before a corresponding digital signage device is available to the system. For example, an administrator of a digital signage management system may be tasked with provisioning ten thousand digital signage devices. The administrator may therefore make an order to purchase the digital signage devices and while waiting for the order to the fulfilled, generate and test the configuration profiles. In this way, the configuration profiles may configure the digital signage devices to launch directly to output of digital content once installed, which is not possible in conventional manual provisioning techniques.

To begin, device identifiers are obtained for each of the digital signage devices, e.g., from a registration template as an input automatically generated by the system using a naming convention or input via a file. The digital signage management system also generates authentication data that is usable to verify the digital signage device to access a network location, e.g., a login name and password usable to access a URL that is specified as including digital content for rendering by the device. This data from the registration template is used to generate the configuration profiles, which may be performed for the ten thousand digital signage devices in this example in seconds, which is also not possible using conventional manual provisioning techniques. For example, an administrator may provide an input to the digital signage management system to initiate generation of one hundred configuration profiles for one hundred digital signage devices. To do so, a registration template is employed that includes a naming convention for device identifiers (e.g., US-SF-xxx) and authentication data, thus arriving at a collection of unique usernames and passwords automatically and without user intervention.

Once generated, the configuration profiles may be tested by the digital signage management system, even before respective digital signage devices are available. The digital signage management system, for instance, may provide the generated configuration profiles sequentially to a single testing digital signage device or set of testing devices. The testing digital signage device then implements the configuration profile to test use of the authentication data as part of the digital signage management system, an ability to obtain digital content specified by the configuration profile, and so forth. Further, this testing may be performed in a manner of seconds. In this way, accuracy of server information (e.g., a network location of the digital content), configuration information, and credentials unique to a specific device identifier may be tested by both the device and the system before deployment, which again is not possible using conventional manual provisioning techniques.

These techniques may be implemented by the digital signage management system to address both managed digital signage devices and unmanaged digital signage devices. Managed digital signage devices are linked to a device management solution that may be cloud-based. Unmanaged digital signage devices are not linked, e.g., are initially limited to inclusion of an operating system, solely. In an implementation, the content management system includes an adapter such that a diverse range of configuration profile are generated that are executable by a diverse range of device configurations and cloud-based management solutions. For example, the content management system may use adapters to generate configuration profiles based on a configuration of the digital signage device that is to utilize the profile. The system, for instance, may determine a type of operating system, hardware, and so on utilized by the device and in response generate a configuration profile for that is compatible with that operating system. In a managed scenario, the digital signage devices may be provisioned remotely using the configuration profiles, which may be fully automated using the digital signage management system. In a non-managed scenario, the configuration profiles are installed locally on the digital signage devices.

Once the configuration profiles are implemented by respective digital signage devices, these devices are configured to launch directly to rendering of digital content when deployed. A signage provisioning module, for instance, may receive as an input a device identifier of a digital signage device to be provisioned. This device identifier is then used to locate a respective configuration profile, which is then communicated back to the digital signage device. The configuration profile is examined by the digital signage device to configure the digital signage device for use as part of the digital signage management system. This may include use of a device identifier and authentication data for verifying permissible access to the system, as well as a content identifier identifying a location, at which, digital content is available for rendering by the device. In this way, the configuration profiles support provisioning of tens of thousands of digital signage devices in a matter of seconds in an efficient and accurate manner that is simply not possible using conventional manual provisioning techniques.

In the following discussion, an example environment is described that may employ the techniques described herein. Example procedures are also described which may be performed in the example environment as well as other environments. Consequently, performance of the example procedures is not limited to the example environment and the example environment is not limited to performance of the example procedures.

### Example Environment

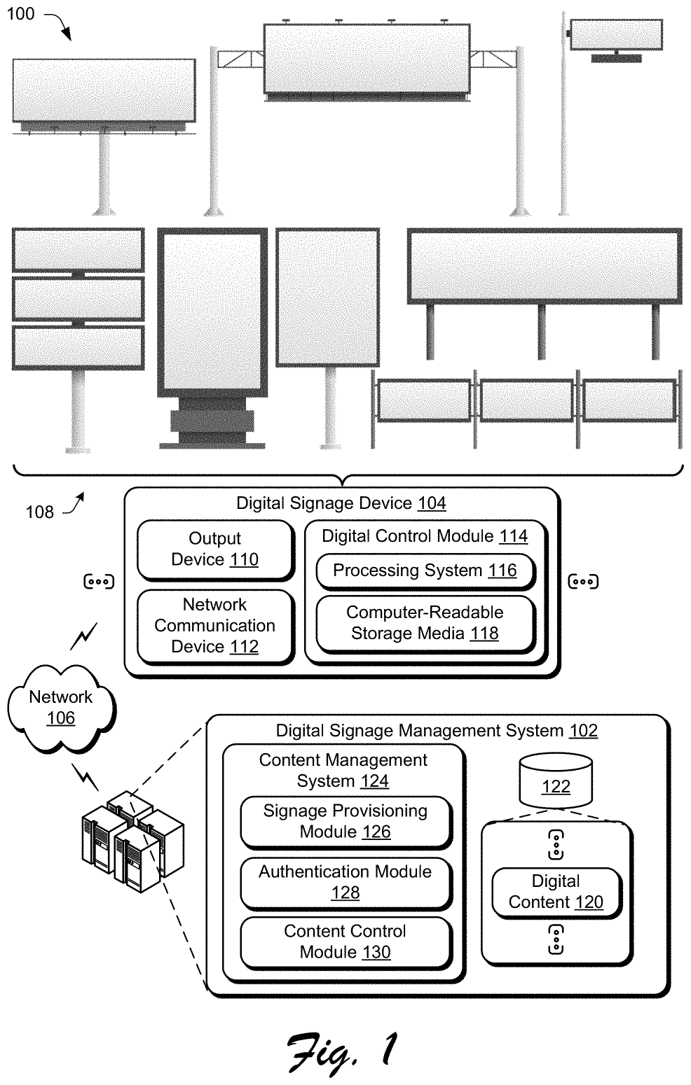

FIG. 1 is an illustration of a digital medium digital signage environment 100 in an example implementation that is operable to employ techniques described herein. The illustrated environment 100 includes a digital signage management system 102 and an example of one of a plurality of digital signage devices 104 that are communicatively coupled to the system via a network 106, e.g., the Internet.

As illustrated, the digital signage device 104 may assume a variety of configurations 108, including roadside use (e.g., road signs and electronic billboards), for use in stores or stadiums, hotels, offices, event and exhibition centers, and so forth. The digital signage device 104 includes an output device 110 configured to render digital content. The output device 110, for instance, may be configured to support visual output through use of a display device that employs an LCD, LED, projector, holograms, and so forth. The output device 110 may also be configured to support audio output, e.g., through use of speakers. Other examples are also contemplated, such as to support tactile output, output of virtual or augmented reality content, and so forth.

The digital signage device 104 also includes a network communication device 112 that is configured to support communication with the digital signage management system 102 via the network 106. The network communication device 112, for instance, may be configured to support wired or wireless communication techniques, e.g., through use of telephone or cellular networks.

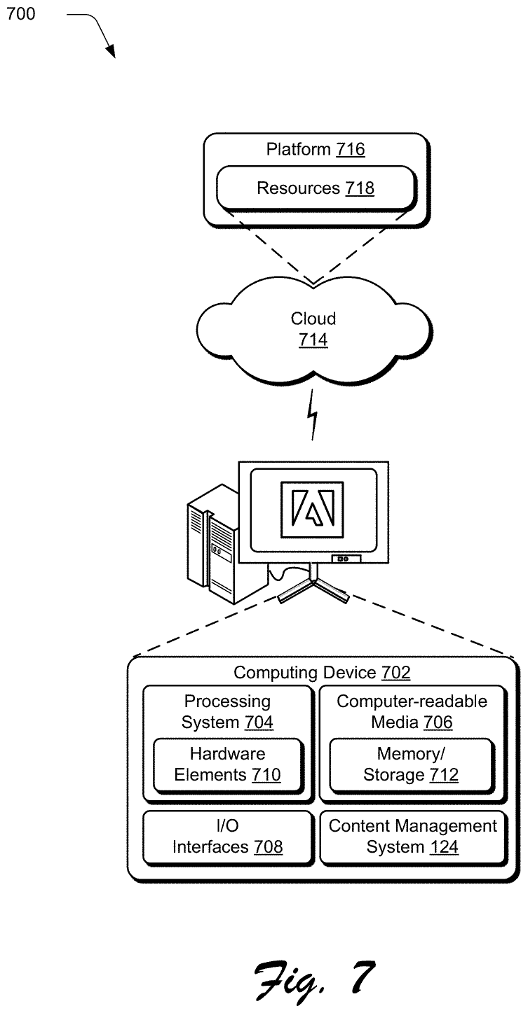

A digital control module 114 is also included by the digital signage device 104 that is configured to control network access as well as storage and rendering of digital content by the output device 110. In the illustrated example, the digital control module 114 is implemented at least partially in hardware through use of a processing system 116 to execute instructions stored by a computer-readable storage media 118. The digital control module 114 thus acts as a “player” of digital content. Operation of the processing system 116 and computer-readable storage media 118 is further described in relation to FIG. 7.

The digital signage management system 102 is configured to control communication and output of digital content 120 to the digital signage devices 104 (e.g., via the network 106), which is illustrated as stored in a storage device 122. To do so, the digital signage management system 102 employs a content management system 124. The content management system 124 includes functionality to provision the digital signage device 104 for operation as part of the digital signage management system 102, which is represented as a signage provisioning module 126. The content management system 124 also includes an authentication module 128 that is usable to verify credentials of the digital signage device 104 in order to access the digital content 120. Additionally, the content management system 124 includes a content control module 130 that is configured to control which items of digital content 120 are provided to respective digital signage devices 104.

As previously described, conventional techniques used to provision digital signage devices for operation with a digital signage management system require a human technician to manually enter configuration information into the digital signage device as well as into the digital signage management system. Further, there is no support for testing this information before deployment of the device. Accordingly, these conventional techniques are prone to error and computationally inefficient.

In the techniques described herein, however, the signage provisioning module 126 is configured to generate configuration profiles that are executable to automatically provision the digital signage devices 104 for operation as part of the system. In this way, the digital signage management system 102 may automatically “set up” tens of thousands of digital signage devices 104 in seconds, which is not possible using conventional techniques. Further discussion of operation of the signage provisioning module 126 to generate configuration profiles and use the configuration profiles to provision the devices is included in the following sections.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Automated Generation of Configuration Profiles

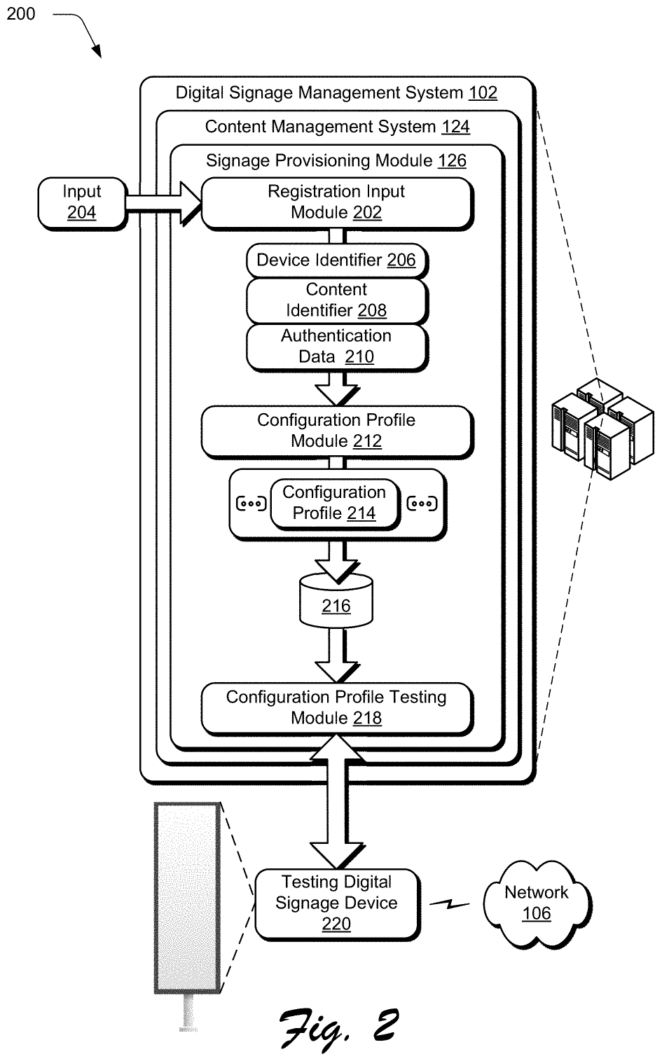

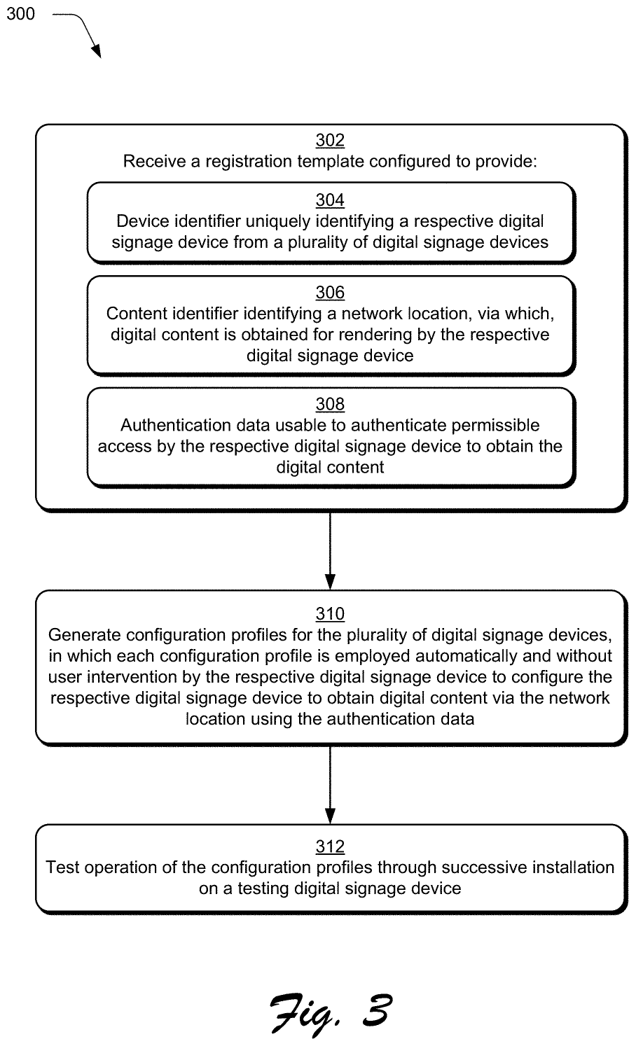

FIG. 2 depicts a system 200 showing operation of the signage provisioning module 126 of FIG. 1 in greater detail. FIG. 3 depicts a procedure 300 in an example implementation of generation of configuration profiles that are executable by digital signage device 104 to automatically provision the devices for operation with a digital signage management system 102.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made interchangeably to FIGS. 2 and 3.

To begin, a registration template is received by the signage provisioning module 126 of the digital signage management system (block 302). A registration input module 202, for instance, may receive an input 204 that includes the registration template. The registration template is configured to provide a device identifier 206 as uniquely identifying a respective digital signage device from a plurality of digital signage devices (block 304). The device identifier 206 may be generated in a variety of ways. In a first example, the input 204 is received by registration input module 202 from a device identifier generation module that is configured to automatically generate the device identifier 206 based on a regular expression of asset tags using a naming convention of the registration template. A naming convention is a set of rules employed by the system for choosing a character sequence for use as the device identifier 206. The device identifier generation module, for instance, may be configured to generate ten thousand device identifiers in real time, e.g., in less than a second, using the naming convention. In a second example, the input 204 is a spreadsheet, comma separated values (CSV) file, or so on that includes a listing of device identifier 206, e.g., from a manufacturer of the digital signage devices 104.

The registration template is also configured to provide a content identifier 208 identifying a network location, via which, digital content 120 is to be obtained for rendering by the respective digital signage device 104 (block 306). The content identifier 208, for instance, may include a uniform resource locator (URL) of the digital signage management system 102, via which, the digital signage device 104 is to obtain the digital content 120. In this way, the digital signage management system 102 may control which content is output to and rendered by the digital signage device 104 by controlling which items of digital content 120 are made available via the network address. The digital content 120 made available via the network address may also include instructions usable to control how the digital content 120 is rendered by the digital signage device 104, e.g., a specified order, amount of time to display each item, and so forth.

Further, the registration template is also configured to provide authentication data 210 usable to authenticate permissible access by the respective digital signage device to obtain the digital content (block 306). The authentication data 210, for instance, may include a login name and password usable to authenticate the digital signage device 104. The authentication data 210 may be generated automatically and without user intervention by the registration input module 202 for each of the device identifiers 206, may be received via a spreadsheet along with the device identifiers 206, and so forth.

The registration template is then passed (e.g., via an API) from the registration input module 202 to a configuration profile module 212. The configuration profile module 212 is configured to generate configuration profiles 214 for the plurality of digital signage devices 104, which are illustrated as stored in a storage device 216. Each configuration profile 214 is employed automatically and without user intervention by the respective digital signage device to configure the device to obtain the digital content 120 via the network location using the authentication data 210 (block 310).

The configuration profile module 212, for instance, may configure the configuration profiles 214 as a file that is readable by a digital control module 114 of a respective digital signage device 104. The configuration profiles 214, for instance, may be configured in a language-independent data format, examples of which include a JavaScript Object Notation (JSON) file format or an extensible markup language file format. As a result, the configuration profiles 214 may be accessed by a wide range of different software and hardware digital signage device configurations and in this way overcome the challenges of conventional techniques that required specialized knowledge to interact with the diverse range of digital signage devices.

A user, for example, may interact via a user interface with the digital signage management system 102 to manage ten thousand digital signage devices 104. To add these devices to the system, the signage provisioning module 126 may employ a device identifier generation module to automatically generate device identifiers 206 usable to uniquely identify each digital signage device 104 within the system, e.g., using a set of rules of a naming convention.

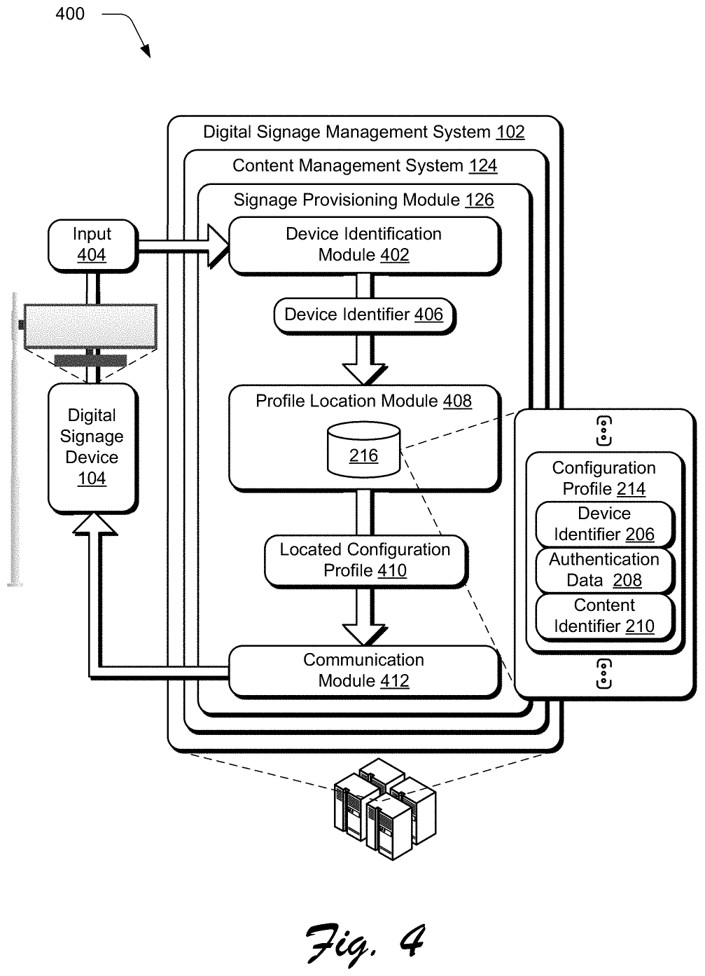

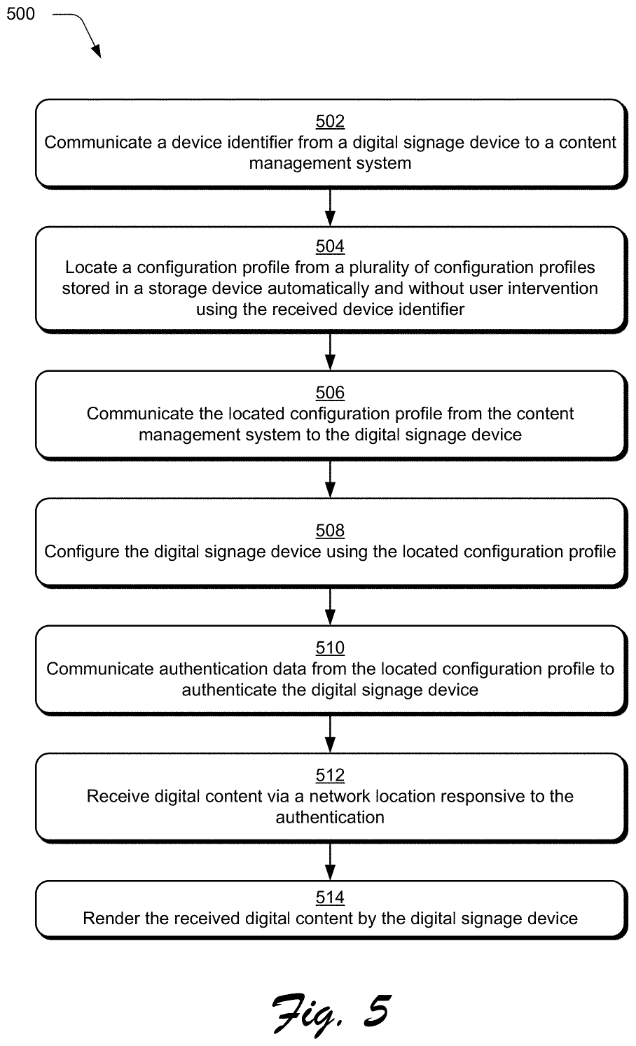

Content identifiers 208 and authentication data 210 are also generated and used as a basis to form configuration profiles 214 for each of the device identifier 206. In this way, the configuration profiles 214 may be generated even before the digital signage devices 104 become available and may be performed in seconds, automatically and without user intervention, which is not possible using conventional manual techniques. Further, because each of these configuration profiles 214 may be generated in a language-independent data format, these configuration profiles 214 may be utilized by a wide range of digital signage devices 104 configurations by being agnostic to a particular software platform employed by the devices. The configuration profiles 214 are used by the digital control module 114 to access digital content based on the content identifier 208 using the authentication data 210 as further described in relation to FIGS. 4-5.

Operation of the configuration profiles are then tested by a profile testing module 218 through successive installation on a testing digital signage device 220 (block 312). Continuing with the previous example, the configuration profiles may be generated even before a digital signage device 104 becomes available. The user, for instance, may be tasked with adding the ten thousand digital signage devices 104. In response, the user may order the devices, and while waiting for the order to be fulfilled, cause the configuration profiles 214 to be generated and then tested. The testing, for instance, may employ a single testing digital signage device 220 (or set of testing devices), on which, the configuration profiles 214 are installed successively and tested. This may include testing access via the network 106 to a network address associated with the content identifier 208 and verification of access using the authentication data 210. As a result, the user may verify that the configuration profiles 214 function as desired with respect to both the testing digital signage device 220 as well as the digital signage management system 102, itself, before installation on a respective digital signage device 104. Further discussion of installation of the configuration profiles on the digital signage devices 104 is included in the following section.

Digital Signage Device Provisioning using Configuration profiles

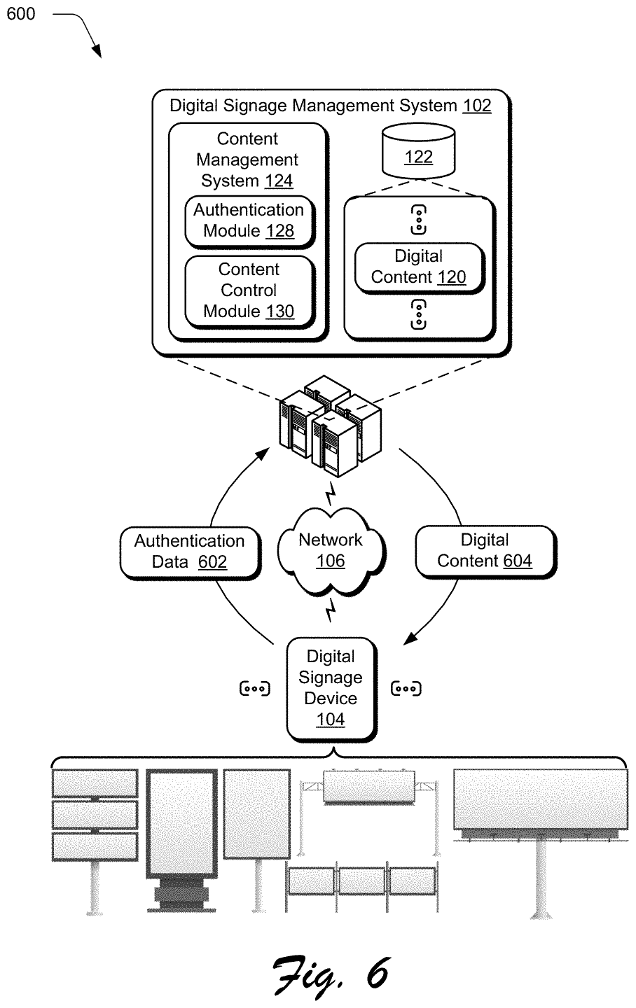

FIG. 4 depicts a system 400 showing operation of the signage provisioning module 126 of FIG. 1 in greater detail as installing configuration profiles on respective digital signage device 104. FIG. 5 depicts a procedure 500 in an example implementation of use of the configuration profiles 214 as generated with respect to FIGS. 2-3 to provision digital signage devices 104. FIG. 6 depicts a system 600 in which the digital signage device 104, as provisioned using the configuration profile 214, launch automatically to obtain and render digital content 120 from a digital signage management system 102.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made interchangeably to FIGS. 4-6.

In order to provision the digital signage device 104 in this example, a device identifier is communicated from a digital signage device 104 to a content management system 124 (block 502). The content management system 124, for instance, may include a device identifier module 402 that is configured to receive an input 404 from the digital signage device 104 that includes the device identifier 406. This may be performed locally via a local network connection, e.g., for unmanaged device configurations. This may also be performed remotely via the network 106, e.g., for managed device configurations. Other examples are also contemplated, e.g., in which the digital signage device 104 does not include a device identifier but rather relies on a device identifier 406 from the configuration profile.

A configuration profile 410 is located from a plurality of configuration profiles 214 stored in a storage device 216 automatically and without user intervention by a profile location module 408 using the received device identifier 406 (block 504). The profile location module 408, for instance, may match the device identifier 406 with a device identifier 206 associated with a respective configuration profile 214.

The located configuration profile is communicated from a communication module 412 of the content management system 124 to the digital signage device 104 (block 506). Again, this may be performed using local or remote network connections supported by the network communication device 112 of the digital signage device 104.

The digital signage device is then configured using the located configuration profiled (block 508). A digital control module 114, for instance, may act as a media player of the digital content 120 and as such is responsible for obtaining, storing, and rendering of the digital content 120. To do so, the digital control module 114 inputs the located configuration profile 410. As previously described, the located configuration profile 410 is configured in a language-independent data format, such as a markup language (e.g., XML), a JavaScript Object Notation (JSON) file format, and so forth and thus is compatible with a wide range of digital signage device 104 configurations. In another implementation, the located configuration profile 410 is executable and includes adapters that may be employed based on a software platform employed by the digital signage device 104.

The digital signage device 104, once provisioned, is then configured to launch directly to obtain digital content 120 automatically and without user intervention. The digital signage device 104, for instance, may communicate authentication data 602 from the located configuration profile 410 to authenticate the digital signage device 104 (block 510) with the digital signage management system 102. The authentication module 128 may then verify the authentication data 602 with a locally stored version to ensure that the digital signage device 104 “is what it says it is.” Once verified, access to the digital content 120 is permitted via the network address. As a result, digital content 120 is received by the digital signage device 104 via a network location responsive to the authentication (block 512) and then rendered by the output device 110 of the digital signage device 104 (block 514). A variety of other examples are also contemplated.

Example System and Device

FIG. 7 illustrates an example system generally at 700 that includes an example computing device 702 that is representative of one or more computing systems and/or devices that may implement the various techniques described herein. This is illustrated through inclusion of the content management system 124. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital signage content management environment, a system comprising:
a configuration profile module implemented at least partially in hardware of a computing device to generate configuration profiles for the plurality of digital signage devices from a registration template, the registration template including:
a device identifier uniquely identifying a respective digital signage device from a plurality of digital signage devices;
a content identifier identifying a network location, via which, digital content is obtained; and
authentication data usable to authenticate permissible access by the respective digital signage device to the digital content; and
a signage provisioning module implemented at least partially in hardware of the computing device to provision the plurality of digital signage devices automatically and without user intervention using respective configuration profiles.

2. The system as described in claim 1, wherein the configuration profiles are configured in a language-independent data format.

3. The system as described in claim 1, wherein the configuration profile module is configured to an adapter as part of generating the configuration profile such that the configuration profile is compatible with a respective said digital signage device.

4. The system as described in claim 1, wherein the signage provisioning module further comprises:
a device identification module implemented at least partially in hardware of the computing device to obtain a device identifier from a particular digital signage device of the plurality of digital signage devices;
a profile location module implemented at least partially in hardware of the computing device to locate a configuration profile automatically and without user intervention from the generated configuration profiles based on the device identifier; and
a communication module implemented at least partially in hardware of the computing device to communicate the located configuration profile to the particular digital signage device automatically and without user intervention to cause the digital signage device to execute the located configuration profile to obtain digital content via the network location using the authentication data automatically and without user intervention.

5. The system as described in claim 1, wherein the authentication data includes a login name and password, the network location is specified via a uniform resource locator (URL), and the device identifier is an asset tag.

6. The system as described in claim 1, wherein the registration template is configured as a spreadsheet file or a comma separated values file.

7. The system as described in claim 1, wherein the configuration profiles are configured to provision the plurality of digital signage devices remotely via a network.

8. The system as described in claim 1, wherein the configuration profiles are executable to determine a geographic location from the device identifier and to select the content identifier from a plurality of content identifiers based on the geographic location.

9. The system as described in claim 1, further comprising a registration testing module implemented at least partially in hardware of the computing device to test operation of the configuration profiles through successive installation on a testing digital signage device.

10. In a digital signage content management environment, a method implemented by at least one computing device, the method comprising:
receiving, by the at least one computing device, a registration template configured to provide:
a device identifier uniquely identifying a respective digital signage device from a plurality of digital signage devices;
a content identifier identifying a network location, via which, digital content is obtained for rendering by the respective digital signage device; and
authentication data usable to authenticate permissible access by the respective digital signage device to the network location; and
generating, by the at least one computing device, configuration profiles for the plurality of digital signage devices;
receiving, by the at least one computing device, a device identifier from a particular digital signage device of the plurality of digital signage devices;
locating, by the at least one computing device, a configuration profile automatically and without user intervention from the generated configuration profiles based on the device identifier; and
communicating, by the at least one computing device, the located configuration profile to cause the particular digital signage device to execute the located configuration profile automatically and without user intervention to obtain digital content via the network location using the authentication data automatically and without user intervention.

11. The method as described in claim 10, further comprising:
receiving, by the at least one computing device, the authentication data from the particular digital signage device;
authenticating, by the at least one computing device, that the particular digital signage device is permitted to receive the digital content; and
communicating, by the at least one computing device the digital content via a network for receipt by the particular digital signage device thereby causing the particular digital signage device to render the digital content.

12. The method as described in claim 10, wherein the configuration profiles are configured in a language-independent data format.

13. The method as described in claim 10, wherein the authentication data includes a login name and password, the network location is specified via a uniform resource locator (URL), and the device identifier is an asset tag.

14. The method as described in claim 10, wherein the configuration profiles are executable to determine a geographic location from the device identifier and to select the content identifier from a plurality of content identifiers based on the geographic location.

15. In a digital signage content management environment, a system comprising:
means for generating configuration profiles for the plurality of digital signage devices from a registration template, the registration template including:
a device identifier uniquely identifying a respective digital signage device from a plurality of digital signage devices;
a content identifier identifying a network location, via which, digital content is obtained; and
authentication data usable to authenticate permissible access by the respective digital signage device to the digital content; and
means for provisioning the plurality of digital signage devices automatically and without user intervention using respective configuration profiles.

16. The system as described in claim 15, wherein the configuration profiles are configured in a language-independent data format.

17. The system as described in claim 15, wherein the authentication data includes a login name and password, the network location is specified via a uniform resource locator (URL), and the device identifier is an asset tag.

18. The system as described in claim 15, wherein the configuration profiles are executable to determine a geographic location from the device identifier and to select the content identifier from a plurality of content identifiers based on the geographic location.

19. The system as described in claim 15, further comprising means for testing operation of the configuration profiles through successive installation on a testing digital signage device.

20. The system as described in claim 15, wherein the configuration profiles are configured to provision the plurality of digital signage devices remotely via a network.
